(19) United States
(12) Patent Application Publication
(10) Pub. No.: US 2018/0163993 A1
(43) Pub. Date: Jun. 14, 2018

(54) WATER HEATER APPLIANCE AND A METHOD FOR OPERATING THE SAME

(71) Applicant: Haier US Appliance Solutions, Inc., Wilmington, DE (US)

(72) Inventors: Paul Goodjohn, Crestwood, KY (US); Shaun Michael Ward, Louisville, KY (US)

(21) Appl. No.: 15/374,091

(22) Filed: Dec. 9, 2016

(51) Int. Cl. F24H 9/20; G05D 23/13

(52) U.S. Cl. CPC F24H 9/2007; G05D 23/132

(57) ABSTRACT

A water heater appliance and associated methods of operation are provided for regulating an output temperature of a mixing valve to a target temperature. The method includes determining the output temperature and an error value between the output temperature and the target temperature. A controller regulates the mixing valve according to a proportional-integral-derivative (PID) control algorithm for adjusting the output temperature to the predetermined target temperature. A proportional gain, an integral gain, and a derivative gain of the PID control algorithm vary according to a gain schedule depending on the error value between the output temperature and the predetermined target temperature.

### FIELD OF THE INVENTION

The present subject matter relates generally to water heater appliances and methods for operating water heater appliances for improved output temperature control.

### BACKGROUND OF THE INVENTION

Certain water heater appliances include a tank therein. Heating elements, such as gas burners, electric resistance elements, or induction elements, heat water within the tank during operation of such water heater appliances. During operation, relatively cold water flows into the tank, and the heating elements operate to heat such water to a predetermined temperature. In particular, the heating elements generally heat water within the tank to a very high temperature. However, the volume of available hot water is generally limited to the volume of the tank.

To provide relatively large volumes of heated water from limited capacity tanks, certain water heater appliances utilize mixing valves. Such mixing valves permit hot water within the water heater's tank to be stored at relatively high temperatures. The mixing valves mix the relatively hot water with relatively cold water in order to bring the temperature of such water down to suitable and/or more usable temperatures. For example, mixing valves may adjust the ratio of hot and cold water to supply heated water at an output temperature suitable for showering, washing hands, etc.

Certain conventional water heater appliances use proportional-integral-derivative (PID) control algorithms to regulate the mixing valve such that an output temperature of the mixing valve reaches a target temperature, e.g., 120 degrees Fahrenheit. Such PID control algorithms typically have fixed proportional, integral, and derivative gains. The control input to the mixing valve is a function of these gains and an error value between the output temperature and the target temperature. Notably, fixed gains may result in a mixing valve response that is too aggressive or too conservative depending on the selected fixed gains and how close the output temperature is to the target temperature, i.e., depending on the magnitude of the error value. For example, relatively large fixed gains will result in the output temperature quickly reaching the target temperature, but also frequently results in large, undesirable overshoots of the target temperature. By contrast, relatively small gains may cause the output temperature to slowly approach the target temperature, but may minimize overshoot and improve stability of the output temperature once the target temperature is reached.

Accordingly, a water heater appliance with features for improving the control of the output temperature of a mixing valve would be useful. More specifically, a method of operating a mixing valve of a water heater appliance to quickly cause an output temperature of the mixing valve to reach the target temperature while minimizing overshoot and improving stability once the target temperature is reached would be particularly beneficial.

### BRIEF DESCRIPTION OF THE INVENTION

The present subject matter provides a water heater appliance and associated methods of operation for regulating an output temperature of a mixing valve to a target temperature. The method includes determining the output temperature and an error value between the output temperature and the target temperature. A controller regulates a mixing valve according to a proportional-integral-derivative (PID) control algorithm for adjusting the output temperature to the predetermined target temperature. A proportional gain, an integral gain, and a derivative gain of the PID control algorithm vary according to a gain schedule depending on the error value between the output temperature and the predetermined target temperature. Additional aspects and advantages of the invention will be set forth in part in the following description, or may be apparent from the description, or may be learned through practice of the invention.

In one exemplary embodiment, a method for controlling a water heater appliance is provided. The method includes determining an output temperature of the water heater appliance and determining an error value between the output temperature and a predetermined target temperature of the water heater appliance. The method further includes regulating a mixing valve according to a proportional-integral-derivative (PID) control algorithm for adjusting the output temperature to the predetermined target temperature, the PID control algorithm having a proportional gain, an integral gain, and a derivative gain. The proportional gain, the integral gain, and the derivative gain vary according to a gain schedule depending on the error value between the output temperature and the predetermined target temperature.

In another exemplary embodiment, a water heater appliance is provided. The water heater appliance includes a tank defining an interior volume for holding water, a cold water conduit configured for directing water into the interior volume of the tank, and a heating assembly for heating water within the tank. A heated water conduit is configured for directing heated water out of the interior volume of the tank and a mixing valve is in fluid communication with the cold water conduit and the heated water conduit, the mixing valve being configured for selectively mixing water from the heated water conduit and water from the cold water conduit to provide mixed water to a mixed water conduit. A controller is operably coupled to the heating assembly and the mixing valve. The controller is configured for determining an output temperature of the mixed water within the mixed water conduit and determining an error value between the output temperature and a predetermined target temperature of the water heater appliance. The controller is further configured for regulating the mixing valve according to a proportional-integral-derivative (PID) control algorithm to adjust the output temperature to the predetermined target temperature, the PID control algorithm having a proportional gain, an integral gain, and a derivative gain. The proportional gain, the integral gain, and the derivative gain vary according to a gain schedule depending on the error value between the output temperature and the predetermined target temperature.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a water heater appliance according to an exemplary embodiment of the present subject matter.

FIG. 2 provides a schematic view of certain components of a water heater system including the exemplary water heater appliance of FIG. 1 according to an exemplary embodiment of the present subject matter.

FIG. 3 illustrates a method for controlling a water heater appliance according to an exemplary embodiment of the present subject matter.

FIG. 4 is a plot illustrating an output temperature of a mixing valve of the exemplary water heater appliance of FIG. 1, where an appliance controller is implementing a conventional single-stage PID control algorithm with aggressive gains.

FIG. 5 is a plot illustrating the output temperature of the mixing valve of the exemplary water heater appliance of FIG. 1, where the appliance controller is implementing a conventional single-stage PID control algorithm with conservative gains.

FIG. 6 is a plot illustrating the output temperature of the mixing valve of the exemplary water heater appliance of FIG. 1, where the appliance controller is implementing a four-stage variable-gain PID control algorithm.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

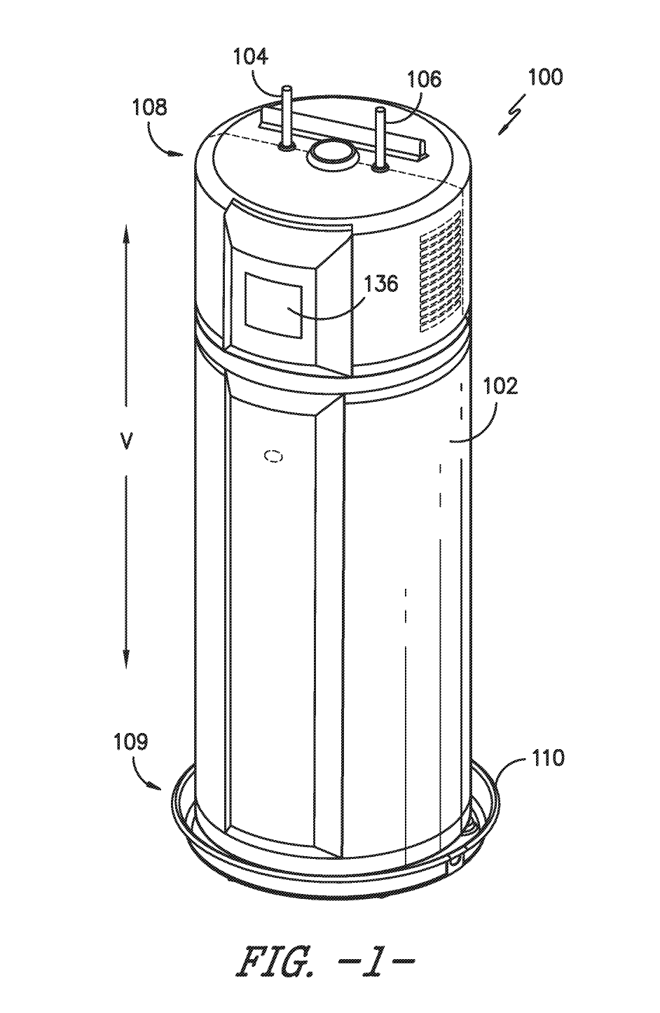

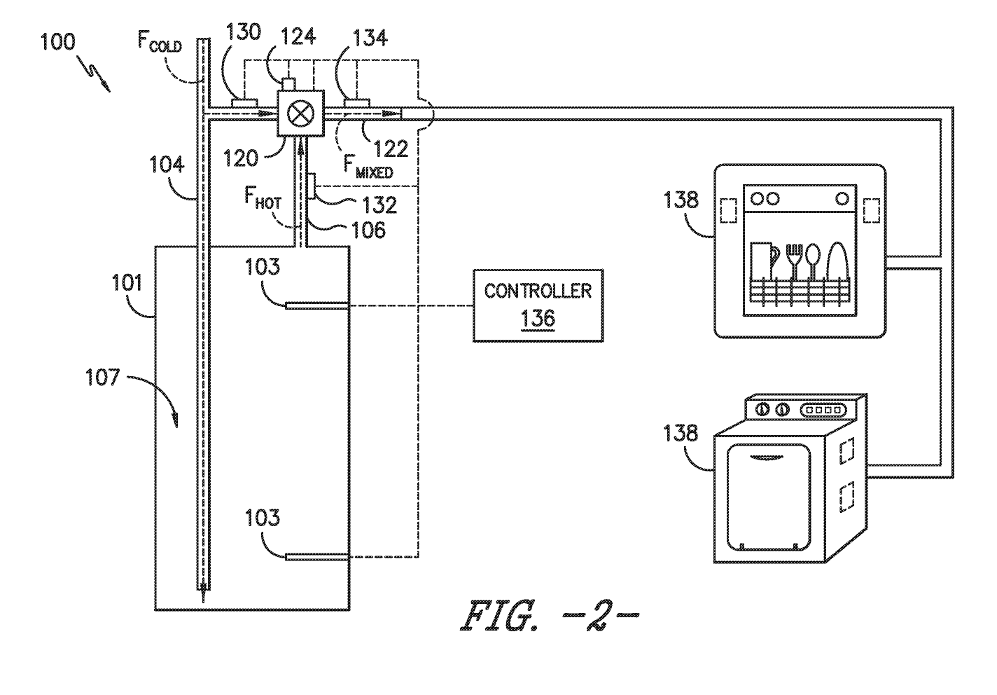

FIG. 1 provides a perspective view of a water heater appliance 100 according to an exemplary embodiment of the present subject matter. Water heater appliance 100 includes a casing 102. A tank 101 (FIG. 2) and heating elements 103 (FIG. 2) are positioned within casing 102 for heating water therein. Heating elements 103 may include a gas burner, a heat pump, an electric resistance element, a microwave element, an induction element, a sealed heat pump system or any other suitable heating element or combination thereof. As will be understood by those skilled in the art and as used herein, the term “water” includes purified water and solutions or mixtures containing water and, e.g., elements (such as calcium, chlorine, and fluorine), salts, bacteria, nitrates, organics, and other chemical compounds or substances.

Water heater appliance 100 also includes a cold water conduit 104 and a hot water conduit 106 that are both in fluid communication with a chamber 107 (FIG. 2) defined by tank 101. As an example, cold water from a water source, e.g., a municipal water supply or a well, can enter water heater appliance 100 through cold water conduit 104 (shown schematically with arrow labeled F_{cold} in FIG. 2). From cold water conduit 104, such cold water can enter chamber 107 of tank 101 wherein it is heated with heating elements 103 to generate heated water. Such heated water can exit water heater appliance 100 at hot water conduit 106 and, e.g., be supplied to a bath, shower, sink, or any other suitable feature.

Water heater appliance 100 extends longitudinally between a top portion 108 and a bottom portion 109 along a vertical direction V. Thus, water heater appliance 100 is generally vertically oriented. Water heater appliance 100 can be leveled, e.g., such that casing 102 is plumb in the vertical direction V, in order to facilitate proper operation of water heater appliance 100. A drain pan 110 is positioned at bottom portion 109 of water heater appliance 100 such that water heater appliance 100 sits on drain pan 110. Drain pan 110 sits beneath water heater appliance 100 along the vertical direction V, e.g., to collect water that leaks from water heater appliance 100 or water that condenses on an evaporator of water heater appliance 100. It should be understood that water heater appliance 100 is provided by way of example only and that the present subject matter may be used with any suitable water heater appliance.

FIG. 2 provides a schematic view of certain components of water heater appliance 100. As may be seen in FIG. 2, water heater appliance 100 includes a mixing valve 120 and a mixed water conduit 122. Mixing valve 120 is in fluid communication with cold water conduit 104, hot water conduit 106, and mixed water conduit 122. As discussed in greater detail below, mixing valve 120 is configured for selectively directing water from cold water conduit 104 and hot water conduit 106 into mixed water conduit 122 in order to regulate an output temperature of water within mixed water conduit 122.

As an example, mixing valve 120 can selectively adjust between a first position and a second position. In the first position, mixing valve 120 can permit a first flow rate of relatively cool water from cold water conduit 104 (shown schematically with arrow labeled F_{cold} in FIG. 2) into mixed water conduit 122 and mixing valve 120 can also permit a first flow rate of relatively hot water from hot water conduit 106 (shown schematically with arrow labeled Fₕₒₜ in FIG. 2) into mixed water conduit 122. In such a manner, water within mixed water conduit 122 (shown schematically with arrow labeled F_{mixed} in FIG. 2) can have a first particular temperature when mixing valve 120 is in the first position. Similarly, mixing valve 120 can permit a second flow rate of relatively cool water from cold water conduit 104 into mixed water conduit 122 and mixing valve 120 can also permit a second flow rate of relatively hot water from hot water conduit 106 into mixed water conduit 122 in the second position. The first and second flow rates of the relatively cool water and relatively hot water are different such that water within mixed water conduit 122 can have a second particular temperature when mixing valve 120 is in the second position. In such a manner, mixing valve 120 can regulate the temperature of water within mixed water conduit 122 and adjust the temperature of water within mixed water conduit 122 between the first and second particular temperatures.

It should be understood that, in certain exemplary embodiments, mixing valve 120 is adjustable between more positions than the first and second positions. In particular, mixing valve 120 may be adjustable between any suitable number of positions in alternative exemplary embodiments. For example, mixing valve 120 may be infinitely adjustable in order to permit fine-tuning of the temperature of water within mixed water conduit 122.

Mixing valve 120 may be an electronic mixing valve. In addition, mixing valve 120 may be positioned within casing 102, e.g., above tank 101. Thus, mixing valve 120 may be integrated within water heater appliance 100. According to still other exemplary embodiments, mixing valve 120 may be positioned remote from water heater appliance 100, e.g., proximate a water consuming device.

Water heater appliance 100 also includes a position sensor 124. Position sensor 124 is configured for determining a position of mixing valve 120. Position sensor 124 can monitor the position of mixing valve 120 in order to assist with regulating the temperature of water within mixed water conduit 122. For example, position sensor 124 can determine when mixing valve 120 is in the first position or the second position in order to ensure that mixing valve 120 is properly or suitably positioned depending upon the temperature of water within mixed water conduit 122 desired or selected. Thus, position sensor 124 can provide feedback regarding the status or position of mixing valve 120.

According to the illustrated exemplary embodiment, water heater appliance 100 also includes a cold water conduit flow detector or first temperature sensor 130, a hot water conduit flow detector or second temperature sensor 132, and a mixed water conduit flow detector or third temperature sensor 134. First temperature sensor 130 is positioned on or proximate cold water conduit 104 and is configured for measuring a temperature of water within cold water conduit 104. Second temperature sensor 132 is positioned on or proximate hot water conduit 106 and is configured for measuring a temperature of water within hot water conduit 106. Third temperature sensor 134 is positioned on or proximate mixed water conduit 122 and is configured for measuring a temperature of water within mixed water conduit 122. According to an exemplary embodiment, third temperature sensor 134 is positioned a sufficient distance downstream of mixing valve 120 (e.g., greater than ten centimeters from mixing valve 120) to allow the cold and hot water to mix fully and provide an accurate temperature measurement.

Water heater appliance 100 further includes a controller 136 that is configured for regulating operation of water heater appliance 100. Controller 136 is in, e.g., operative communication with heating elements 103, mixing valve 120, position sensor 124, and temperature sensors 130, 132, and 134. Thus, controller 136 can selectively activate heating elements 103 in order to heat water within chamber 107 of tank 101. Similarly, controller 136 can selectively operate mixing valve 120 in order to adjust a position of mixing valve 120 and regulate a temperature of water within mixed water conduit 122.

Controller 136 includes memory and one or more processing devices such as microprocessors, CPUs or the like, such as general or special purpose microprocessors operable to execute programming instructions or micro-control code associated with operation of water heater appliance 100. The memory can represent random access memory such as DRAM, or read only memory such as ROM or FLASH. The processor executes programming instructions stored in the memory. The memory can be a separate component from the processor or can be included onboard within the processor. Alternatively, controller 136 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

Controller 136 can be positioned at a variety of locations. In the exemplary embodiment shown in FIG. 1, controller 136 is positioned within water heater appliance 100, e.g., as an integral component of water heater appliance 100. In alternative exemplary embodiments, controller 136 may positioned away from water heater appliance 100 and communicate with water heater appliance 100 over a wireless connection or any other suitable connection, such as a wired connection.

Controller 136 can operate heating elements 103 to heat water within chamber 107 of tank 101. As an example, a user can select or establish a set-point temperature for water within chamber 107 of tank 101, or the set-point temperature for water within chamber 107 of tank 101 may be a default value. Based upon the set-point temperature for water within chamber 107 of tank 101, controller 136 can selectively activate heating elements 103 in order to heat water within chamber 107 of tank 101 to the set-point temperature for water within chamber 107 of tank 101. The set-point temperature for water within chamber 107 of tank 101 can be any suitable temperature. For example, the set-point temperature for water within chamber 107 of tank 101 may be between about one hundred and forty degrees Fahrenheit and about one hundred and eighty-degrees Fahrenheit.

Controller 136 can also operate mixing valve 120 to regulate the temperature of water within mixed water conduit 122. For example, controller 136 can adjust the position of mixing valve 120 in order to regulate the temperature of water within mixed water conduit 122. As an example, a user can select or establish a predetermined target temperature of mixing valve 120, or the target temperature of mixing valve 120 may be a default value. The target temperature of mixing valve 120 can be any suitable temperature. For example, the target temperature of mixing valve 120 may be between about one hundred degrees Fahrenheit and about one hundred and twenty degrees Fahrenheit. In particular, the target temperature of mixing valve 120 may be selected such that the target temperature of mixing valve 120 is less than the set-point temperature for water within chamber 107 of tank 101.

Based upon the target temperature of mixing valve 120, controller 136 can adjust the position of mixing valve 120 in order to change or tweak a ratio of relatively cool water flowing into mixed water conduit 122 from cold water conduit 104 and relatively hot water flowing into mixed water conduit 122 from hot water conduit 106. More specifically, as described in detail below, controller 136 can implement a proportional-integral-derivative (PID) control algorithm to regulate the temperature of water within mixed water conduit 122. In such a manner, mixing valve 120 can utilize water from cold water conduit 104 and hot water conduit 106 to regulate the temperature of water within mixed water conduit 122.

As best illustrated in FIG. 2, according to an exemplary embodiment of the present subject matter, mixed water conduit 122 may be in fluid communication with one or more water consuming devices 138. Water consuming devices 138 may be configured to selectively draw water from mixed water conduit 122 as needed for operation. As used herein, “water consuming device” may refer to any suitable plumbing fixture, household appliance, or any other suitable device configured to draw water from water heater appliance 100. Moreover, water heater appliance 100 may be configured to supply one or more than two water consuming devices or fixtures according to alternative embodiments.

The present disclosure is further directed to methods 200 for operating water heater appliances. Method 200 can be used to operate any suitable water heater system. For example, method 200 may be utilized to operate water heater appliance 100 (FIGS. 1 and 2). In this regard, for example, controller 136 may be programmed to implement method 200 and the various steps thereof as discussed herein. However, it should be appreciated that aspects of method 200 may be used to operate any suitable water heating appliance and to control an associated mixing valve to regulate an output temperature to the target temperature.

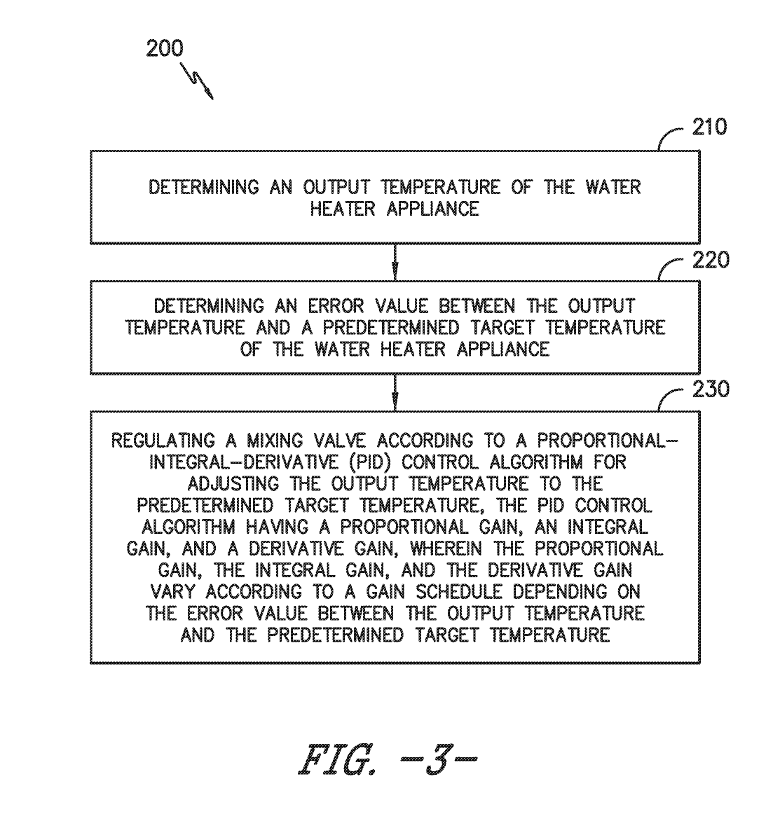

Referring now specifically to FIG. 3, method 200 includes, at step 210, determining an output temperature of the water heater appliance. According to an exemplary embodiment, the output temperature is the temperature of the mixed water exiting a mixing valve of the water heater appliance. Therefore, the output temperature is the temperature of the water that is supplied to the water consuming appliance (neglecting lines losses). Using water heater appliance 100 as an example, the output temperature may be measured by third temperature sensor 134 on mixed water conduit 122. More specifically, third temperature sensor 134 may be positioned a sufficient distance downstream of mixing valve 120 (e.g., greater than ten centimeters from mixing valve 120) to allow the cold and hot water to mix fully and provide an accurate temperature measurement. However, it should be appreciated that the output temperature may be measured at other suitable location downstream of mixing valve 120 using any suitable type of temperature sensor.

Method 200 further includes, at step 220, determining an error value between the output temperature (e.g., determined at step 210) and a predetermined target temperature of the water heater appliance. The target temperature is the desired temperature of the water exiting the mixing valve (e.g., the desired output temperature). The target temperature may be set by the manufacturer as a factory default, may be set by a user using a controller or a control interface, or may be a temperature requested by a water consuming appliance. In addition, the target temperature may be fixed or may vary with time.

Method 200 further includes, at step 230, regulating a mixing valve according to a proportional-integral-derivative (PID) control algorithm for adjusting the output temperature to the predetermined target temperature. The PID control algorithm is a feedback-based control algorithm that continuously calculates an error value (e.g., determined at step 220) and applies a control input (e.g., to mixing valve 120) based on proportional, integral, and derivative terms to minimize the error value (e.g., to drive the output temperature to the target temperature). According to an exemplary embodiment, the control input is used to set a position of a mixing valve to control the proportion of hot and cold water to adjust the output temperature.

When using the PID control algorithm, the control input is a weighted sum of the proportional, integral, and derivative terms. In general, the proportional term accounts for present error values, the integral term accounts for past error values, and the derivative term accounts for possible future error values. Notably, the integral term accumulates over time and may be used to generate a larger control input as the integral error value accumulates. An exemplary PID control algorithm is shown in the following equation, wherein Kₚ, Kᵢ, and K_{d} are the proportional, integral, and derivative gain constants, respectively:

u(t)=Kₚe(t)+Kₗ∫e(t)dt+K_{d}(d e(t)/dt)

Notably, the input to the PID control algorithm is the error value (e.g., determined at step 220). As explained above, when the proportional, integral, and derivative gains are fixed, the PID control algorithm is typically better for either rapidly responding to large error values or providing improved stability when the error value is small (i.e., when the output temperature is close to the target temperature). More specifically, large gains provide rapid response to large temperature excursions (i.e., larger error values), but result in poor stability when the error value is small. By contrast, small gains are ideal for fine-tuning the output temperature when the output temperature is close to the target temperature, but provide a very slow response to larger error values.

Therefore, according to exemplary embodiments of the present subject matter, the proportional gain, the integral gain, and the derivative gain vary according to a gain schedule depending on the error value between the output temperature and the predetermined target temperature. In this regard, the gain values are dependent on the error value, and relatively larger gains may be used when the error value is large, while relatively smaller gains may be used when the error value is small. In this manner, rapid response may be achieved to drive the output temperature to the target temperature when the error value is large. However, when the error value is small, relatively smaller gains may be used to provide improved stability of the output temperature around the target temperature.

An exemplary gain schedule including proportional gains (Kₚ), integral gains (Kₗ), and derivative gains (K_{d}) is illustrated below in Table 1.

TABLE 1
Exemplary Four-Stage Gain Schedule

| | Error Value | | | |
|---|---|---|---|---|
| Stage | (ΔT in ° F.) | Kₚ | Kᵢ | K_{d} |
| 1 | ΔT >8 | 10 | 1 | 0 |
| 2 | 3 < ΔT < 8 | 5 | 2.5 | 0.1 |
| 3 | 1 < ΔT < 3 | 2 | 1.5 | 0.4 |
| 4 | ΔT <1 | 0 | 0 | 0 |

It should be appreciated that the four-stage gain schedule illustrated above is used only for the purpose of explaining aspects of the present subject matter. According to exemplary embodiments, the gain schedules may have any suitable number of stages for achieving any suitable purpose. For example, according to an exemplary embodiment, the gain schedule may include only two gain stages. The first gain stage may include relatively large gains, for example, when the error value is greater than ten degrees, greater than twenty degrees, or greater than forty degrees. The second gain stage may include relatively small gains, for example, when the error value is less than ten degrees. Other gain schedules are contemplated and within the scope of the present disclosure.

According to one exemplary embodiment, the PID controller may include a plurality of gain schedules, and may select a specific gain schedule from the plurality of gain schedules to achieve a specific purpose. For example, the gain schedule may be selected to reduce an overshoot of the predetermined target temperature. In this regard, the gains may be very small when the output temperature approaches within a certain threshold of the target temperature, e.g., within about twenty percent of the target temperature. It should be appreciated, that as used herein, terms of approximation, such as “approximately,” “substantially,” or “about,” refer to being within a ten percent margin of error.

According to another exemplary embodiment, the gain schedule may be selected to minimize a time to reach the predetermined target temperature when the error value exceeds a predetermined high error threshold. In this regard, for example, when an error value percentage (i.e., error value divided by the target temperature) is greater than about fifty percent, the gain values may be very large. According to another exemplary embodiment, the gain schedule may be selected to improve the stability of the output temperature when the error value falls below a predetermined low value threshold. In this regard, for example, when the error value percentage is less than about five percent the gains may be very small to provide improved stability.

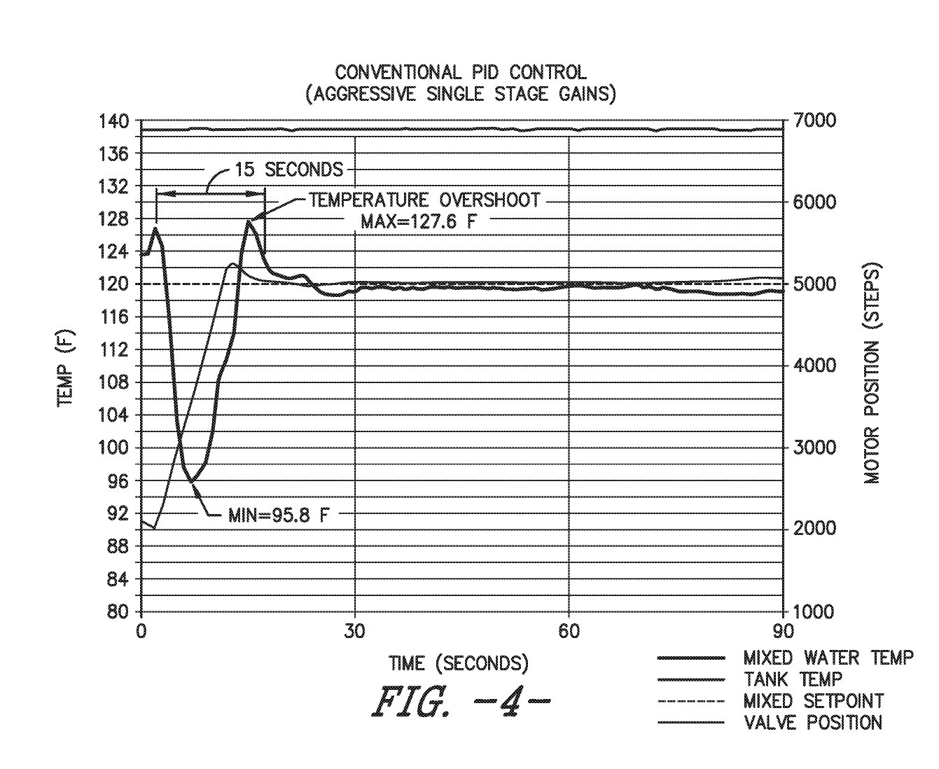

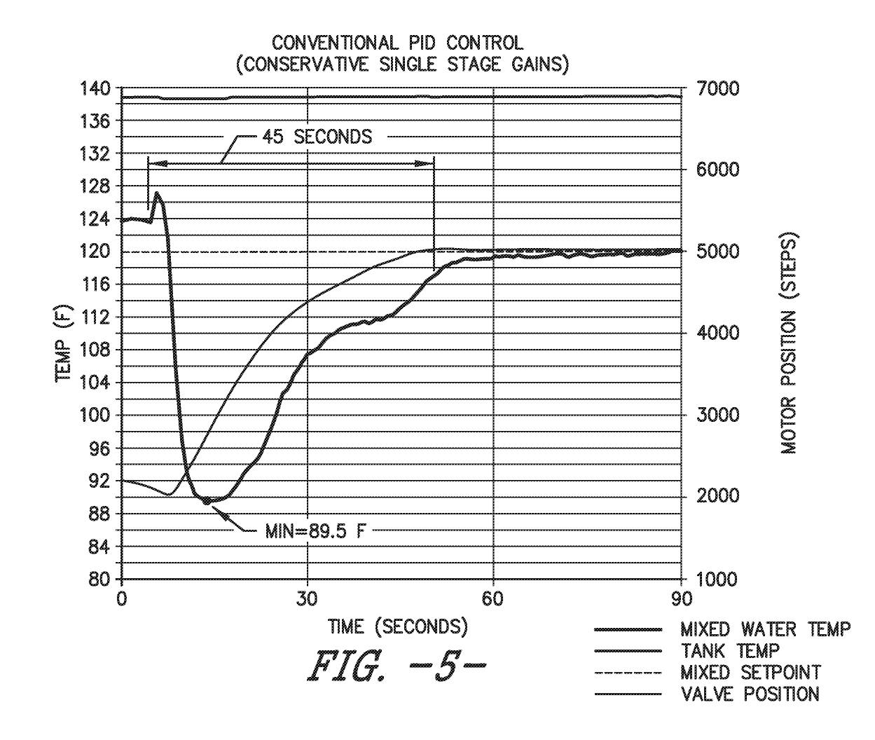

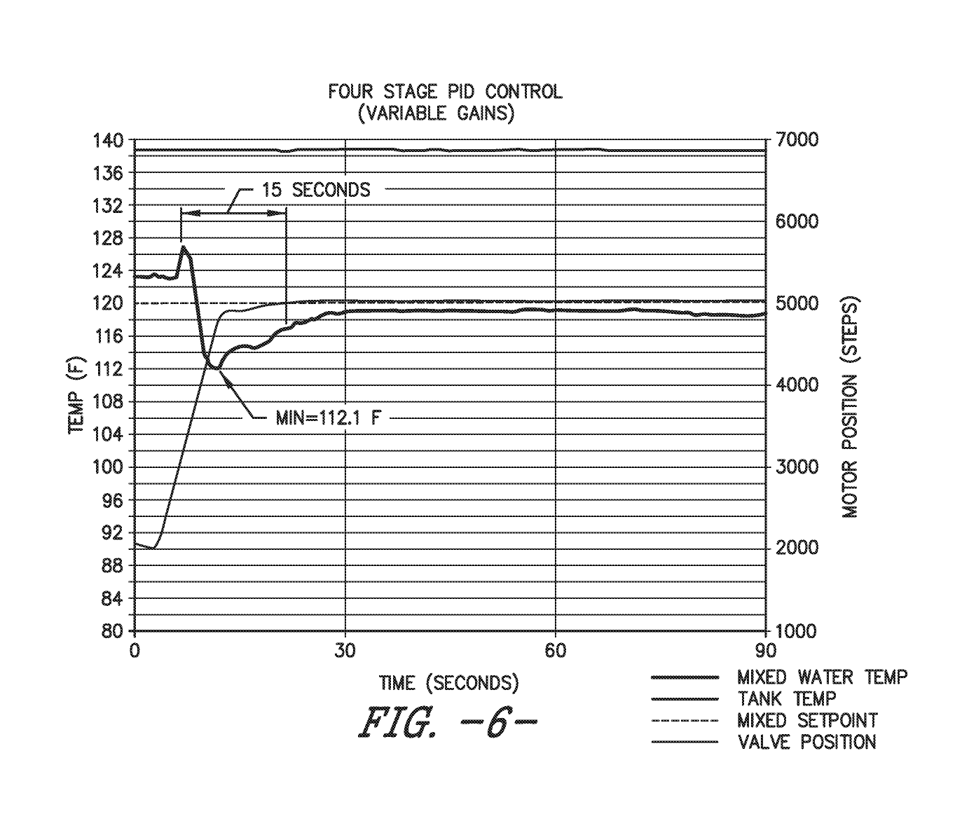

Referring now to FIGS. 4 through 6, the performance of a PID controller using various gain schedules will be described. These plots provide the output temperature of the mixing valve (i.e., the “mixed water temp”) when trying to provide water at the target temperature (i.e., the “mixed setpoint”). More specifically, FIG. 4 illustrated a fixed, single-stage gain schedule with aggressive or relatively large gains. FIG. 5 illustrates a fixed, single-stage gain schedule to conservative or relatively small gains. FIG. 6 illustrates a four-stage variable gain schedule according to an exemplary embodiment of the present subject matter. According to the exemplary embodiments described herein, the tank temperature stays at a substantially constant 139 degrees Fahrenheit, and the target temperature of the mixed output is fixed at 120 degrees Fahrenheit. It should be appreciated that these temperature values are only exemplary and are not intended to limit the scope of the present subject matter.

Referring now specifically to FIG. 4, the PID controller is configured for mixing water from the hot and cold water conduit into a mixed stream of water. The controller adjusts the position of the mixing valve, and thus the proportion of hot and cold water, to drive the output temperature to the target temperature. As illustrated, upon initial mixing, the mixed water output temperature is approximately 127 degrees Fahrenheit. In this regard, the error value at initial mixing is approximately 7 degrees. To compensate, the PID controller adjusts the mixing valve by increasing the proportion of cold water to drop the output temperature. However, because the PID control algorithm in FIG. 4 has large gains, the adjustment is accordingly very large and the mixed water output temperature drops to 95.8 degrees Fahrenheit (i.e., a 24.2 degree error value). The PID controller causes the mixing valve to overcompensate again, and the mixed stream output temperature overshoots the target temperature by 7.6 degrees Fahrenheit before the mixing valve finally normalizes near the target temperature (e.g., within one or two percent of the target temperature). Due to the aggressive gains, the mixed stream output temperature reached and maintains within two degrees of the target temperature after only fifteen seconds. Notably, however, the stability of the output temperature once the target temperature is reaches is not as consistent, varying as much as two percent or more from the target temperature during steady state operation.

By contrast, referring now to FIG. 5, the same results may be compared using conservative gains. Similar to the plot above, upon initial mixing, the mixed water output temperature is approximately 127 degrees Fahrenheit (i.e., a 7 degree error value). To compensate, the PID controller adjusts the mixing valve by increasing the proportion of cold water to drop the temperature. Although the initial adjustment of mixing valve drops the output temperature to 89.5 degrees Fahrenheit (a 30.5 degree error value), the conservative gains used thereafter result in a slow approach to the target temperature. Therefore, the mixing valve finally normalizes the output temperature near the target temperature (e.g., within one or two percent of the target temperature) after forty-five seconds. Although the time to reach relative stability at the target temperature is three times as long as the aggressive gains approach (FIG. 4), the stability near the target temperature is improved, varying no more than about one degree or within one percent of the target temperature during steady state operation.

Referring now to FIG. 6, the mixed stream output temperature is illustrated when the mixing valve is controlled using a PID control algorithm with variable gains. More particularly, the control algorithm used in FIG. 6 is a four-stage variable-gain control algorithm, similar to that described above and illustrated in Table 1. Similar to the plots above, upon initial mixing, the mixed water output temperature is approximately 127 degrees Fahrenheit (i.e., a 7 degree error value). To compensate, the PID controller adjusts the mixing valve by increasing the proportion of cold water to drop the temperature. In this case, the gains have been adjusted such that the initial adjustment of mixing valve drops the output temperature to only 112.1 degrees Fahrenheit (a 7.9 degree error value). The first stages of the control algorithm include aggressive or moderately aggressive gains to drive the output temperature to within one or two percent of the target temperature after fifteen seconds (similar to the aggressive gains approach of FIG. 4). However, after the output temperature is close the target temperature, the gains are decreased and the stability of the output temperature near the target temperature is improved. In this manner, the variable gain control algorithm achieves the benefits of the aggressive gains approach and the conservative gains approach, by minimizing the time to reach the target temperature and providing good stability near the target temperature (i.e., at steady state).

Although the plots illustrated in FIGS. 4 through 6 provide an exemplary comparison of the operation of the water heater appliance using a PID control algorithm, with aggressive single-stage, conservative single-stage, and variable multi-stage gains, it should be appreciated that this is only one exemplary embodiment. Other gain schedules may be used, resulting in different benefits or being configured to achieve different goals. Use of such gain schedules remains within the scope of the present subject matter. In addition, although the PID control algorithm disclosed herein is described as being used to adjust a mixing valve of a water heater appliance, it should be appreciated that aspects of the present subject matter may be similarly applied to mixing valves for other appliances and may be used in different applications.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for controlling a water heater appliance, the method comprising:
determining an output temperature of the water heater appliance;
determining an error value between the output temperature and a predetermined target temperature of the water heater appliance; and
regulating a mixing valve according to a proportional-integral-derivative (PID) control algorithm for adjusting the output temperature to the predetermined target temperature, the PID control algorithm having a proportional gain, an integral gain, and a derivative gain,
wherein the proportional gain, the integral gain, and the derivative gain vary according to a gain schedule depending on the error value between the output temperature and the predetermined target temperature.

2. The method of claim 1, wherein the proportional gain, the integral gain, and the derivative gain decrease as the output temperature approaches the predetermined target temperature.

3. The method of claim 1, wherein the gain schedule is selected from a plurality of predetermined gain schedules, wherein the selected gain schedule reduces an overshoot of the predetermined target temperature.

4. The method of claim 1, wherein the gain schedule is selected from a plurality of predetermined gain schedules, wherein the selected gain schedule minimizes a time to reach the predetermined target temperature when the error value exceeds a predetermined high error value threshold.

5. The method of claim 1, wherein the gain schedule is selected from a plurality of predetermined gain schedules, wherein the selected gain schedule improves stability of the output temperature when the error value falls below a predetermined low error value threshold.

6. The method of claim 1, wherein the gain schedule has two stages.

7. The method of claim 1, wherein the gain schedule has four or more stages.

8. The method of claim 1, wherein the gain schedule comprises:
the proportional gain is about ten, the integral gain is about one, and the derivative gain is about zero when the error value is greater than eight degrees Fahrenheit;
the proportional gain is about five, the integral gain is about 2.5, and the derivative gain is about 0.1 when the error value is between three degrees Fahrenheit and eight degrees Fahrenheit;
the proportional gain is about two, the integral gain is about 1.5, and the derivative gain is about 0.4 when the error value is between one degree Fahrenheit and three degrees Fahrenheit; and
the proportional gain, the integral gain, and the derivative gain are about zero when the error value is between zero degrees Fahrenheit and one degree Fahrenheit.

9. The method of claim 1, wherein the output temperature is measured at an output of a mixing valve of the water heater appliance.

10. A water heater appliance comprising:
a tank defining an interior volume for holding water;
a cold water conduit configured for directing water into the interior volume of the tank;
a heating assembly for heating water within the tank;
a heated water conduit configured for directing heated water out of the interior volume of the tank;
a mixing valve in fluid communication with the cold water conduit and the heated water conduit, the mixing valve being configured for selectively mixing water from the heated water conduit and water from the cold water conduit to provide mixed water to a mixed water conduit; and
a controller operably coupled to the heating assembly and the mixing valve, the controller being configured for:
determining an output temperature of the mixed water within the mixed water conduit;
determining an error value between the output temperature and a predetermined target temperature of the water heater appliance; and
regulating the mixing valve according to a proportional-integral-derivative (PID) control algorithm to adjust the output temperature to the predetermined target temperature, the PID control algorithm having a proportional gain, an integral gain, and a derivative gain,
wherein the proportional gain, the integral gain, and the derivative gain vary according to a gain schedule depending on the error value between the output temperature and the predetermined target temperature.

11. The water heater appliance of claim 10, further comprising a temperature sensor positioned on the mixed water conduit for measuring the output temperature of the mixed water.

12. The water heater appliance of claim 10, wherein the proportional gain, the integral gain, and the derivative gain decrease as the output temperature approaches the predetermined target temperature.

13. The water heater appliance of claim 10, wherein the gain schedule is selected from a plurality of predetermined gain schedules, wherein the selected gain schedule reduces an overshoot of the predetermined target temperature.

14. The water heater appliance of claim 10, wherein the gain schedule is selected from a plurality of predetermined gain schedules, wherein the selected gain schedule minimizes a time to reach the predetermined target temperature when the error value exceeds a predetermined high error value threshold.

15. The water heater appliance of claim 10, wherein the gain schedule is selected from a plurality of predetermined gain schedules, wherein the selected gain schedule improves stability of the output temperature when the error value falls below a predetermined low error value threshold.

16. The water heater appliance of claim 10, wherein the gain schedule has two stages.

17. The water heater appliance of claim 10, wherein the gain schedule has four or more stages.

18. The water heater appliance of claim 10, wherein the gain schedule comprises:
the proportional gain is about ten, the integral gain is about one, and the derivative gain is about zero when the error value is greater than eight degrees Fahrenheit;
the proportional gain is about five, the integral gain is about 2.5, and the derivative gain is about 0.1 when the error value is between three degrees Fahrenheit and eight degrees Fahrenheit;
the proportional gain is about two, the integral gain is about 1.5, and the derivative gain is about 0.4 when the error value is between one degree Fahrenheit and three degrees Fahrenheit; and
the proportional gain, the integral gain, and the derivative gain are about zero when the error value is between zero degrees Fahrenheit and one degree Fahrenheit.
